(19) United States
(12) Patent Application Publication
(10) Pub. No.: US 2020/0186280 A1
(43) Pub. Date: Jun. 11, 2020

(54) Method And Apparatus For Channel State Information Acquisition And Reporting In Mobile Communications

(71) Applicant: MediaTek Singapore Pte. Ltd., Singapore (SG)

(72) Inventor: Abdelkader Medles, Cambridge (GB)

(21) Appl. No.: 16/706,595

(22) Filed: Dec. 6, 2019

Related U.S. Application Data
(60) Provisional application No. 62/775,998, filed on Dec. 6, 2018.

(51) Int. Cl. H04L 1/00; H04L 5/00; H04B 7/06; H04W 52/02

(52) U.S. Cl. CPC H04L 1/0026; H04L 5/0057; H04W 52/0216; H04B 7/0632; H04L 5/005; H04B 7/0626

(57) ABSTRACT

Various solutions for channel state information (CSI) acquisition and reporting with respect to user equipment and network apparatus in mobile communications are described. An apparatus may enter into a power saving mode. The apparatus may monitor a wake-up indication (WUI) while in the power saving mode. The apparatus may determine whether the WUI is received from a network node. The apparatus may transmit channel quality information to the network node in an event that the WUI is received.

### CROSS REFERENCE TO RELATED PATENT APPLICATION(S)

The present disclosure is part of a non-provisional application claiming the priority benefit of U.S. Patent Application No. 62/775,998, filed on 6 Dec. 2018, the content of which is incorporated by reference in its entirety.

### TECHNICAL FIELD

The present disclosure is generally related to mobile communications and, more particularly, to channel state information (CSI) acquisition and reporting with respect to user equipment and network apparatus in mobile communications.

### BACKGROUND

Unless otherwise indicated herein, approaches described in this section are not prior art to the claims listed below and are not admitted as prior art by inclusion in this section.

In New Radio (NR), for a user equipment (UE) in the connected mode, data exchange with the network is expected to be sporadic. The UE will spend most of its time only for monitoring physical downlink control channel (PDCCH). Even for data intensive activities such as video streaming, with improvements in data rates in NR, it is expected that the video data is buffered fairly quickly, and the UE drops into a state of data inactivity during which only PDCCH monitoring takes place. Such state will cause unnecessary power consumption and is not beneficial for UE power management.

A wake-up indication (WUI) mechanism is proposed as an enhancement to the discontinuous reception (DRX) mechanism for power saving at UE side. The WUI may be used to indicate to a UE to expect activity. The UE may be configured to monitor the WUI on predetermined occasions. Upon receiving a WUI, the UE may wake up to monitor a configured search space for DL/UL scheduling. Without receiving a WUI, the UE may keep staying in the power saving mode. However, the WUI mechanism may raise some problems.

When using the DRX mechanism, in addition to monitoring PDCCH for activity, the on duration of the DRX mechanism further provides a window during which link maintenance can be performed. The network node needs to receive link maintenance information about the channel before being able to schedule the UE. If the on duration is dropped since it is replaced by the WUI mechanism, the background link maintenance can no longer be performed. The use of WUI mechanism compounds the problem of absence of link maintenance information at the UE wake-up time, since the UE may have been in a sleep mode for a long time. When the WUI is used to signal to the UE, the network node may not know on which beam to transmit the WUI. Assuming that the WUI is a very reliable signal/channel and may not need beam knowledge, the subsequent CSI report request at the start or before the wake-up duration is able to transmit to the UE without the link maintenance information.

Accordingly, in the newly introduced WUI mechanism, how to perform link maintenance activities for a UE in the power saving mode or sleep mode becomes an important issue for the newly developed wireless communication network. Therefore, it is needed to provide better schemes to properly acquire and provide channel quality information to the network node.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to CSI acquisition and reporting with respect to user equipment and network apparatus in mobile communications.

In one aspect, a method may involve an apparatus entering into a power saving mode. The method may also involve the apparatus monitoring a WUI while in the power saving mode. The method may further involve the apparatus determining whether the WUI is received from a network node. The method may further involve the apparatus transmitting channel quality information to the network node in an event that the WUI is received.

In one aspect, an apparatus may comprise a transceiver which, during operation, wirelessly communicates with a network node of a wireless network. The apparatus may also comprise a processor communicatively coupled to the transceiver. The processor, during operation, may perform operations comprising entering into a power saving mode. The processor may also perform operations comprising monitoring, via the transceiver, a WUI while in the power saving mode. The processor may further perform operations comprising determining whether the WUI is received from the network node. The processor may further perform operations comprising transmitting, via the transceiver, channel quality information to the network node in an event that the WUI is received.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT), Narrow Band Internet of Things (NB-IoT) and Industrial Internet of Things (IIoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a block diagram of an example communication apparatus and an example network apparatus in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to CSI acquisition and reporting with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In NR, for a UE in the connected mode, data exchange with the network is expected to be sporadic. The UE will spend most of its time only for monitoring the PDCCH. Even for data intensive activities such as video streaming, with improvements in data rates in NR, it is expected that the video data is buffered fairly quickly, and the UE drops into a state of data inactivity during which only PDCCH monitoring takes place. Such state will cause unnecessary power consumption and is not beneficial for UE power management.

The DRX mechanism in NR that is inherited from LTE, requires the UE to intermittently monitor PDCCH, allowing the UE to transit to a sleep mode in the interval. The DRX on duration defines a period of time every DRX cycle that the UE monitors for potential activity. On the occurrence of activity during the on duration (e.g., the reception of a DCI scheduling uplink (UL) and/or downlink (DL) activities), the DRX inactivity timer is triggered. The DRX inactivity timer restarts each time data is exchanged between the UE and the network, keeping the UE awake while data exchange takes place. On the expiry of the inactivity timer, the UE goes back to sleep. The UE will monitor for activity again in next on duration.

However, the level of power savings that can be achieved with DRX is down to the network configuration. The percentage of time in a DRX cycle that a UE needs to stay awake for, directly corresponds to the power savings possible. The monitoring window of the DRX mechanism (e.g., DRX on duration) can be quite long (e.g., ≥10 ms) which causes the UE to burn power for downlink monitoring. The UE power consumption is unable to be properly controlled if the network configuration is not well designed.

Accordingly, the WUI mechanism is further proposed as an enhancement to the DRX framework for power saving at UE side. The WUI may be used to indicate to a UE to expect activity. The UE may be configured to monitor the WUI on predetermined occasions. Upon receiving a WUI, the UE may wake up to monitor a configured search space for DL/UL scheduling. Without receiving a WUI, the UE may keep staying in the power saving mode. However, the WUI mechanism may raise another problem.

When using the DRX mechanism, in addition to monitoring PDCCH for activity, the on duration of the DRX mechanism further provides a window during which link maintenance can be performed. The network node needs to receive link maintenance information about the channel before being able to schedule the UE. If the on duration is dropped since it is replaced by the WUI mechanism, the background link maintenance can no longer be performed. The use of WUI mechanism compounds the problem of absence of link maintenance information at the UE wake-up time, since the UE may have been in a sleep mode for a long time. When the WUI is used to signal to the UE, the network node may not know on which beam to transmit the WUI. Assuming that the WUI is a very reliable signal/channel and may not need beam knowledge, the subsequent CSI report request at the start or before the wake-up duration may not be able to transmit to the UE without the link maintenance information. An aperiodic DCI triggered reporting cannot be used since the transmission of the DCI also needs the link maintenance information (e.g., beam knowledge).

In view of the above, the present disclosure proposes a number of schemes pertaining to CSI acquisition and reporting with respect to the UE and the network apparatus. According to the schemes of the present disclosure, the transmission of channel quality information can be triggered by the WUI. Upon receiving the WUI, the UE be configured to actively perform the link maintenance activity without further request from the network node. The link maintenance activity can be performed before the wake-up duration of the UE. Even if the on duration is dropped since it is replaced by the wake-up mechanism, the link maintenance activity can still be performed before the wake-up duration of the UE. Therefore, the network node is able to schedule the UE with the link maintenance information of the channel after waking up the UE from the powering saving mode.

Specifically, when no data is expected or an inactivity timer is expired, the UE may be configured to enter into a power saving mode. The UE may be configured to monitor the WUI while in the power saving mode. The UE may receive a configuration to monitor the WUI on some predetermined occasions. The UE may monitor the WUI on the predetermined occasions according to the configuration. The UE may be configured to determine whether the WUI is received from the network node. In an event that the WUI is received, the UE may be configured to transmit channel quality information to the network node actively.

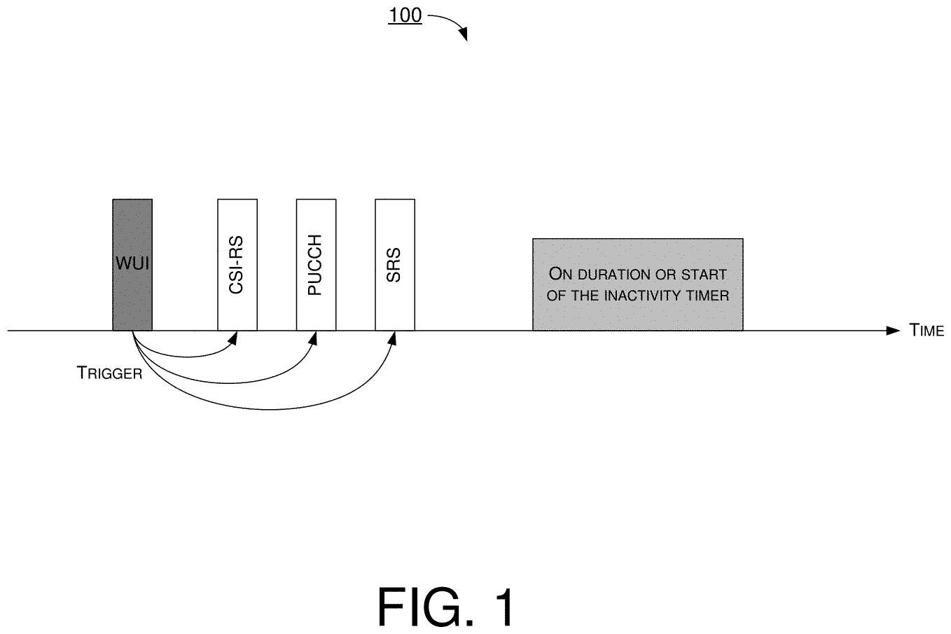

FIG. 1 illustrates an example scenario 100 under schemes in accordance with implementations of the present disclosure. Scenario 100 involves a UE and a network node, which may be a part of a wireless communication network (e.g., an LTE network, an LTE-Advanced network, an LTE-Advanced Pro network, a 5G network, an NR network, an IoT network, an NB-IoT network or an IIoT network). Scenario 100 illustrates the wake-up mechanism proposed in the present disclosure. The UE may be in the power saving mode. The network node may transmit the WUI to wake up the UE for possible DL/UL transmissions. The WUI may trigger the UE to perform the link maintenance activity. For example, after receiving the WUI, the UE may be configured to perform CSI-reference signal (CSI-RS) acquisition (e.g., monitor and receive the CSI-RS). The UE may perform some measurements or calculations to estimate the channel quality according to the CSI-RS. Then, the UE may transmit the channel quality information to the network node. The channel quality information may comprise at least one of a beam management (BM) report, a CSI report, and a sounding reference signal (SRS). With the channel quality information (e.g., BM/CSI report and/or SRS), the network node may be able to properly schedule and communicate with the UE.

The UE may transmit the channel quality information on a physical uplink control channel (PUCCH) or a physical uplink shared channel (PUSCH). The BM/CSI report and/or SRS triggered by the WUI reception may be either periodic or aperiodic configured. The UE may transmit the BM/CSI report and/or SRS to the network node periodically or aperiodically. On the other hand, the UE may transmit the channel quality information before the wake-up duration (e.g., on duration) or a start of an inactivity timer. After receiving the WUI, the UE may prepare to transit from the power saving mode to the wake-up mode or connected mode for possible DL/UL transmissions. The UE may enter into the wake-up duration and/or start the inactivity timer for the scheduled DL/UL transmissions. Therefore, the UE needs to provide the channel quality information to the network node before the wake-up duration or start the inactivity timer. Accordingly, the network node may be able to schedule DL/UL transmissions according to the channel quality information.

In some implementations, the UE may be configured to receive a configuration to transmit the channel quality information. The configuration may comprise a delay between the WUI and the transmission of the channel quality information. The UE may transmit the channel quality information according to the configuration. For example, the aperiodic BM/CSI report on the PUCCH and/or the aperiodic SRS may be configured with details including the delay between the WUI and the BM/CSI report and/or SRS to be transmitted. For aperiodic BM/CSI report, the resource used for CSI calculation may be either periodic or aperiodic. In case of aperiodic CSI-RS, the configuration for the BM/CSI report may include the delay between the WUI and the aperiodic CSI-RS/interference measurements (IM) resources to use. The UE may receive the aperiodic CSI-RS/IM according to the delay. In case of periodic CSI-RS, the configuration for the BM/CSI report may include the CSI-RS/IM resources to use for the CSI calculations. Alternatively, the periodic BM/CSI report on PUCCH and/or the periodic SRS that are triggered by the WUI may be also configured as part of the WUI. In other words, the WUI may comprise the configuration for transmitting the channel quality information.

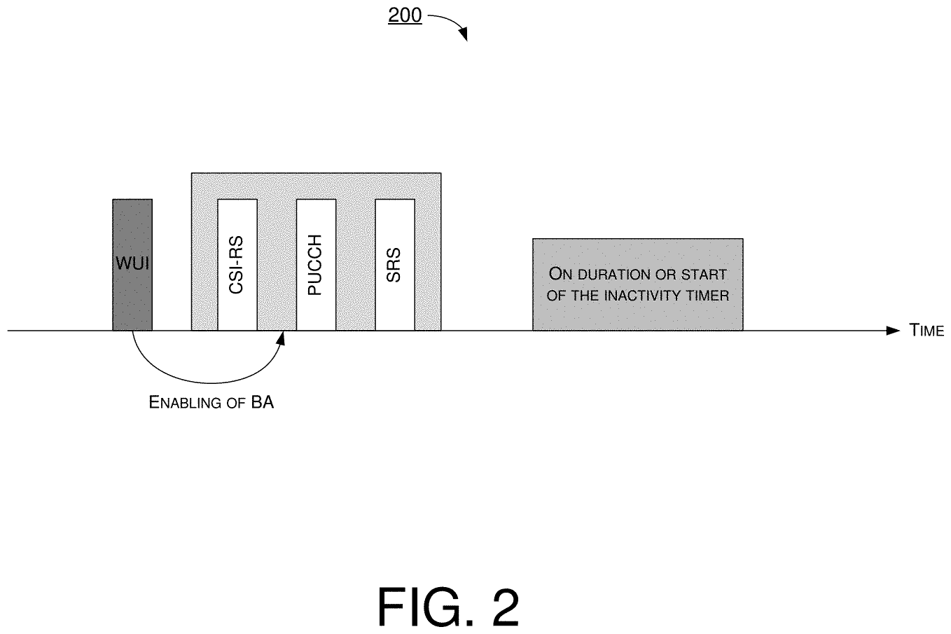

FIG. 2 illustrates an example scenario 200 under schemes in accordance with implementations of the present disclosure. Scenario 200 involves a UE and a network node, which may be a part of a wireless communication network (e.g., an LTE network, an LTE-Advanced network, an LTE-Advanced Pro network, a 5G network, an NR network, an IoT network, an NB-IoT network or an IIoT network). Scenario 200 illustrates the wake-up mechanism proposed in the present disclosure. Similarly, the UE may be in the power saving mode. The network node may transmit the WUI to wake up the UE for possible DL/UL transmissions. The WUI may trigger the UE to perform some background activities. After receiving the WUI, the UE may be configured to activate/enable a background activity (BA) window to perform the background activities. For example, in the BA window, the UE may be configured to perform CSI-RS acquisition (e.g., monitor and receive the CSI-RS). The UE may perform some measurements or calculations to estimate the channel quality according to the CSI-RS. Then, the UE may transmit the channel quality information to the network node in the BA window. The channel quality information may comprise at least one of a BM report, a CSI report, and an SRS. With the channel quality information (e.g., BM/CSI report and/or SRS), the network node may be able to properly schedule and communicate with the UE.

In some implementations, during the BA window, the UE may not need to monitor the PDCCH. The BA window may be configured independently. For example, the UE may receive a configuration for configuring the BA window (e.g., time and/or frequency resources). Alternatively, the BA window may be a fixed window of time before the start of the wake-up duration. The length of the BA window may be configured by the network node or predetermined by the UE. The BA window may not be overlapped with the wake-up duration or the start of the inactivity timer. The BA window may also be overlapped with the wake-up duration or the start of the inactivity timer.

### Illustrative Implementations

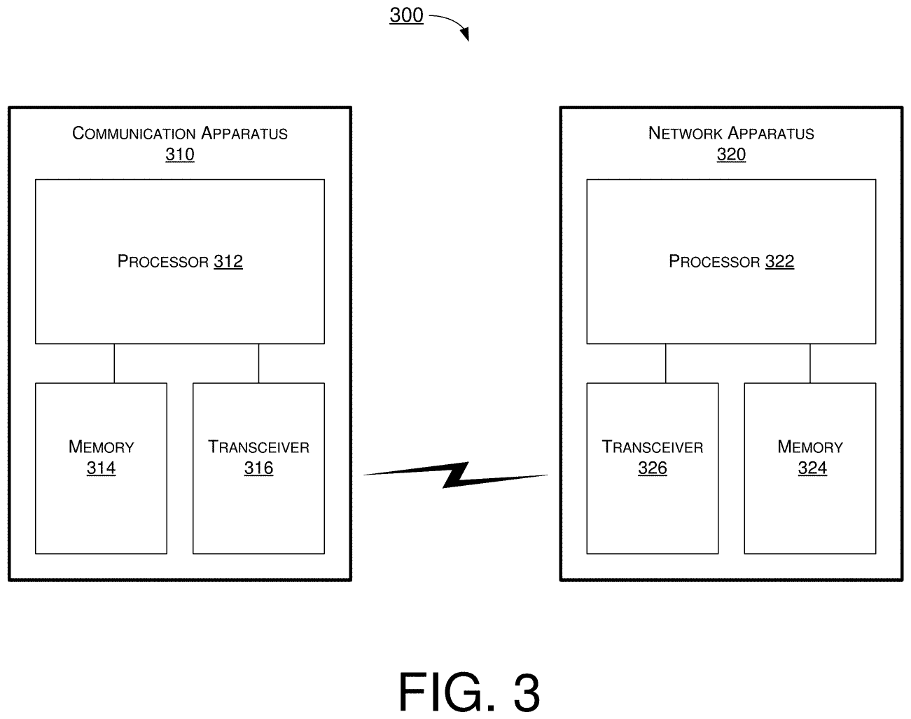

FIG. 3 illustrates an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to CSI acquisition and reporting with respect to user equipment and network apparatus in wireless communications, including scenarios/mechanisms described above as well as process 400 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a base station, a small cell, a router or a gateway. For instance, network apparatus 320 may be implemented in an eNodeB in an LTE, LTE-Advanced or LTE-Advanced Pro network or in a gNB in a 5G, NR, IoT, NB-IoT or IIoT network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including power consumption reduction in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

In some implementations, when no data is expected or an inactivity timer is expired, processor 312 may be configured to enter into a power saving mode. Processor 312 may be configured to monitor, via transceiver 316, the WUI while in the power saving mode. Processor 312 may receive, via transceiver 316, a configuration to monitor the WUI on some predetermined occasions. Processor 312 may monitor the WUI on the predetermined occasions according to the configuration. Processor 312 may be configured to determine whether the WUI is received from network apparatus 320. In an event that the WUI is received, processor 312 may be configured to transmit, via transceiver 316, channel quality information to network apparatus 320 actively.

In some implementations, processor 312 may be in the power saving mode. Network apparatus 320 may transmit, via transceiver 326, the WUI to wake up communication apparatus 310 for possible DL/UL transmissions. The WUI may trigger processor 312 to perform the link maintenance activity. For example, after receiving the WUI, processor 312 may be configured to perform CSI-RS acquisition (e.g., monitor and receive the CSI-RS). Processor 312 may perform some measurements or calculations to estimate the channel quality according to the CSI-RS. Then, processor 312 may transmit, via transceiver 316, the channel quality information to network apparatus 320. The channel quality information may comprise at least one of a BM report, a CSI report, and an SRS. With the channel quality information (e.g., BM/CSI report and/or SRS), network apparatus 320 may be able to properly schedule and communicate with communication apparatus 310.

In some implementations, processor 312 may transmit the channel quality information on a PUCCH or a PUSCH. The BM/CSI report and/or SRS triggered by the WUI reception may be either periodic or aperiodic configured. Processor 312 may transmit, via transceiver 316, the BM/CSI report and/or SRS to network apparatus 320 periodically or aperiodically. On the other hand, processor 312 may transmit the channel quality information before the wake-up duration (e.g., on duration) or a start of an inactivity timer. After receiving the WUI, processor 312 may prepare to transit from the power saving mode to the wake-up mode or connected mode for possible DL/UL transmissions. Processor 312 may enter into the wake-up duration and/or start the inactivity timer for the scheduled DL/UL transmissions. Therefore, processor 312 needs to provide the channel quality information to network apparatus 320 before the wake-up duration or start the inactivity timer. Accordingly, network apparatus 320 may be able to schedule DL/UL transmissions according to the channel quality information.

In some implementations, processor 312 may be configured to receive, via transceiver 316, a configuration to transmit the channel quality information. The configuration may comprise a delay between the WUI and the transmission of the channel quality information. Processor 312 may transmit the channel quality information according to the configuration. For example, the aperiodic BM/CSI report on the PUCCH and/or the aperiodic SRS may be configured with details including the delay between the WUI and the BM/CSI report and/or SRS to be transmitted. For aperiodic BM/CSI report, the resource used for CSI calculation may be either periodic or aperiodic. In case of aperiodic CSI-RS, the configuration for the BM/CSI report may include the delay between the WUI and the aperiodic CSI-RS/interference measurements (IM) resources to use. Processor 312 may receive, via transceiver 316, the aperiodic CSI-RS/IM according to the delay. In case of periodic CSI-RS, the configuration for the BM/CSI report may include the CSI-RS/IM resources to use for the CSI calculations. Alternatively, the periodic BM/CSI report on PUCCH and/or the periodic SRS that are triggered by the WUI may be also configured as part of the WUI. In other words, the WUI may comprise the configuration for transmitting the channel quality information.

In some implementations, processor 312 may be in the power saving mode. Network apparatus 320 may transmit, via transceiver 326, the WUI to wake up communication apparatus 310 for possible DL/UL transmissions. The WUI may trigger processor 312 to perform some background activities. After receiving the WUI, processor 312 may be configured to activate/enable a BA window to perform the background activities. For example, in the BA window, processor 312 may be configured to perform CSI-RS acquisition (e.g., monitor and receive the CSI-RS). Processor 312 may perform some measurements or calculations to estimate the channel quality according to the CSI-RS. Then, processor 312 may transmit, via transceiver 316, the channel quality information to network apparatus 320 in the BA window. The channel quality information may comprise at least one of a BM report, a CSI report, and an SRS. With the channel quality information (e.g., BM/CSI report and/or SRS), network apparatus 320 may be able to properly schedule and communicate with communication apparatus 310.

In some implementations, during the BA window, processor 312 may not need to monitor the PDCCH. The BA window may be configured independently. For example, processor 312 may receive a configuration for configuring the BA window (e.g., time and/or frequency resources). Alternatively, the BA window may be a fixed window of time before the start of the wake-up duration. The length of the BA window may be configured by network apparatus 320 or predetermined by processor 312. The BA window may not be overlapped with the wake-up duration or the start of the inactivity timer. The BA window may also be overlapped with the wake-up duration or the start of the inactivity timer.

### Illustrative Processes

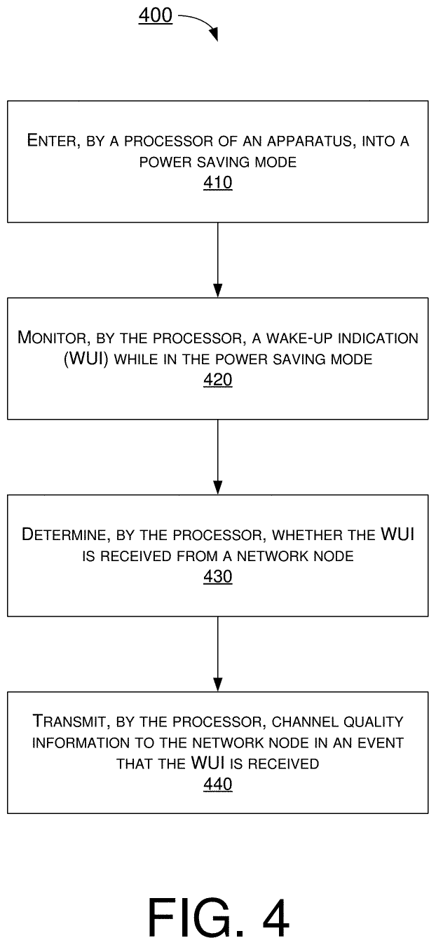

FIG. 4 illustrates an example process 400 in accordance with an implementation of the present disclosure. Process 400 may be an example implementation of above scenarios/schemes, whether partially or completely, with respect to CSI acquisition and reporting with the present disclosure. Process 400 may represent an aspect of implementation of features of communication apparatus 310. Process 400 may include one or more operations, actions, or functions as illustrated by one or more of blocks 410, 420, 430 and 440. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At 410, process 400 may involve processor 312 of apparatus 310 entering into a power saving mode. Process 400 may proceed from 410 to 420.

At 420, process 400 may involve processor 312 monitoring a WUI while in the power saving mode. Process 400 may proceed from 420 to 430.

At 430, process 400 may involve processor 312 determining whether the WUI is received from a network node. Process 400 may proceed from 430 to 440.

At 440, process 400 may involve processor 312 transmitting channel quality information to the network node in an event that the WUI is received.

In some implementations, the channel quality information may comprise at least one of a BM report, a CSI report, and an SRS.

In some implementations, process 400 may involve processor 312 transmitting the channel quality information on a PUCCH or a PUSCH.

In some implementations, process 400 may involve processor 312 transmitting the channel quality information to the network node periodically or aperiodically.

In some implementations, process 400 may involve processor 312 transmitting the channel quality information before an on duration or a start of an inactivity timer.

In some implementations, process 400 may involve processor 312 receiving a configuration to transmit the channel quality information.

In some implementations, the configuration may comprise a delay between the WUI and the transmission of the channel quality information.

In some implementations, the transmission of the channel quality information may be triggered by the WUI.

In some implementations, process 400 may involve processor 312 activating a background activity window within which the channel quality information is transmitted.

In some implementations, process 400 may involve processor 312 performing a CSI-RS acquisition within the background activity window.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
entering, by a processor of an apparatus, into a power saving mode;
monitoring, by the processor, a wake-up indication (WUI) while in the power saving mode;
determining, by the processor, whether the WUI is received from a network node; and
transmitting, by the processor, channel quality information to the network node in an event that the WUI is received.

2. The method of claim 1, wherein the channel quality information comprises at least one of a beam management (BM) report, a channel state information (CSI) report, and a sounding reference signal (SRS).

3. The method of claim 1, wherein the transmitting comprises transmitting the channel quality information on a physical uplink control channel (PUCCH) or a physical uplink shared channel (PUSCH).

4. The method of claim 1, wherein the transmitting comprises transmitting the channel quality information to the network node periodically or aperiodically.

5. The method of claim 1, wherein the transmitting comprises transmitting the channel quality information before an on duration or a start of an inactivity timer.

6. The method of claim 1, further comprising:
receiving, by the processor, a configuration to transmit the channel quality information.

7. The method of claim 6, wherein the configuration comprises a delay between the WUI and the transmitting of the channel quality information.

8. The method of claim 1, wherein the transmitting of the channel quality information is triggered by the WUI.

9. The method of claim 1, further comprising:
activating, by the processor, a background activity window within which the channel quality information is transmitted.

10. The method of claim 9, further comprising:
performing, by the processor, a channel state information-reference signal (CSI-RS) acquisition within the background activity window.

11. An apparatus, comprising:
a transceiver which, during operation, wirelessly communicates with a network node of a wireless network; and
a processor communicatively coupled to the transceiver such that, during operation, the processor performs operations comprising:
entering into a power saving mode;
monitoring, via the transceiver, a wake-up indication (WUI) while in the power saving mode;
determining whether the WUI is received from the network node; and
transmitting, via the transceiver, channel quality information to the network node in an event that the WUI is received.

12. The apparatus of claim 11, wherein the channel quality information comprises at least one of a beam management (BM) report, a channel state information (CSI) report, and a sounding reference signal (SRS).

13. The apparatus of claim 11, wherein, in transmitting the channel quality information, the processor transmits the channel quality information on a physical uplink control channel (PUCCH) or a physical uplink shared channel (PUSCH).

14. The apparatus of claim 11, wherein, in transmitting the channel quality information, the processor transmits the channel quality information to the network node periodically or aperiodically.

15. The apparatus of claim 11, wherein, in transmitting the channel quality information, the processor transmits the channel quality information before an on duration or a start of an inactivity timer.

16. The apparatus of claim 11, wherein, during operation, the processor further performs operations comprising:
receiving, via the transceiver, a configuration to transmit the channel quality information.

17. The apparatus of claim 16, wherein the configuration comprises a delay between the WUI and the transmitting of the channel quality information.

18. The apparatus of claim 11, wherein the transmitting of the channel quality information is triggered by the WUI.

19. The apparatus of claim 11, wherein, during operation, the processor further performs operations comprising:
activating a background activity window within which the channel quality information is transmitted.

20. The apparatus of claim 19, wherein, during operation, the processor further performs operations comprising:
performing a channel state information-reference signal (CSI-RS) acquisition within the background activity window.
